(19) United States
(12) Patent Application Publication
(10) Pub. No.: US 2006/0190840 A1
(43) Pub. Date: Aug. 24, 2006

(54) Semi-automated pipetting aid

(76) Inventor: James Dahle Frost III, The Woodlands, TX (US)

Correspondence Address: MARK A OATHOUT, 3701 KIRBY DRIVE, SUITE 960, HOUSTON, TX, 77098, US

(21) Appl. No.: 11/061,976

(22) Filed: Feb. 18, 2005

(51) Int. Cl. G01F 25/00

(52) U.S. Cl. 715/810; 73/1.74; 422/100

(57) ABSTRACT

A semi-automated pipetting apparatus has a computer monitor with a screen lying in at least a nearly horizontal plane. A screen protector is mounted over the screen. A processing unit runs a computer program and is in communication with the computer monitor to generate a screen display shown on the screen. The screen display indicates at least one target location for the placement of a vial.

### CROSS-REFERENCE TO RELATED APPLICATIONS

Not applicable

### STATEMENTS REGARDING FEDERALLY SPONSORED RESEARCH OR DEVELOPMENT

Not applicable

### REFERENCE TO A MICROFICHE APPENDIX

Not applicable.

### BACKGROUND OF THE INVENTION

Description of the Related Art

In the past, pipettes or vials containing various chemicals and/or samples have been manually organized into well plates in a laboratory or facility. There is great opportunity for human error when attempting to organize numerous identical or nearly identical small vials into the tight space of a well plate or plates. One attempt to improve upon the prior systems is a system with a mounting surface incorporating light emitting diodes (LEDs) into the mounting surface. The LEDs are used to indicate the proper well in a plate for pipetting or vial handling. This is accomplished by placing a vial rack or plate on top of the LED mounting surface and using software to illuminate the correct LED for pipetting or handling.

### BRIEF SUMMARY

A semi-automated pipetting apparatus has a computer monitor with a screen lying in at least a nearly horizontal plane. A screen protector is mounted over the screen. A processing unit runs a computer program and is in communication with the computer monitor to generate a screen display shown on the screen. The screen display indicates at least one target location for the placement of a vial.

### BRIEF DESCRIPTION OF THE SEVERAL VIEWS OF THE DRAWINGS

FIG. 1 is a schematic view of one embodiment of a semi-automated pipetting aid system.

FIG. 2 is a perspective view of one embodiment of a screen protector.

FIG. 3 is a perspective view of one embodiment of pipettor with a wireless port/receiver.

FIG. 4 is a view of a spreadsheet generated as a screen display including schematic instructional text.

FIG. 5 is a view of a spreadsheet generated as a screen display including schematic instructional text.

FIG. 6 is a view of a spreadsheet generated as a screen display including schematic instructional text.

FIG. 7 is a view of a set-up screen display for calibrating the LCD screen including schematic instructional text.

FIG. 8 is a view of a data set-up screen display including schematic instructional text.

FIG. 9 is a view of a screen display for running a bar code scanner including schematic instructional text.

FIG. 10 is a view of a screen display for running a target plate dilution including schematic instructional text.

FIG. 11 is a view of several screen shots of screen displays taken while running the main computer program on data including schematic instructional text and sequence information.

FIG. 12 is a view of fifteen example screen displays generated as a result of running the main computer program including schematic reference information.

### DESCRIPTION of the EMBODIMENT(S)

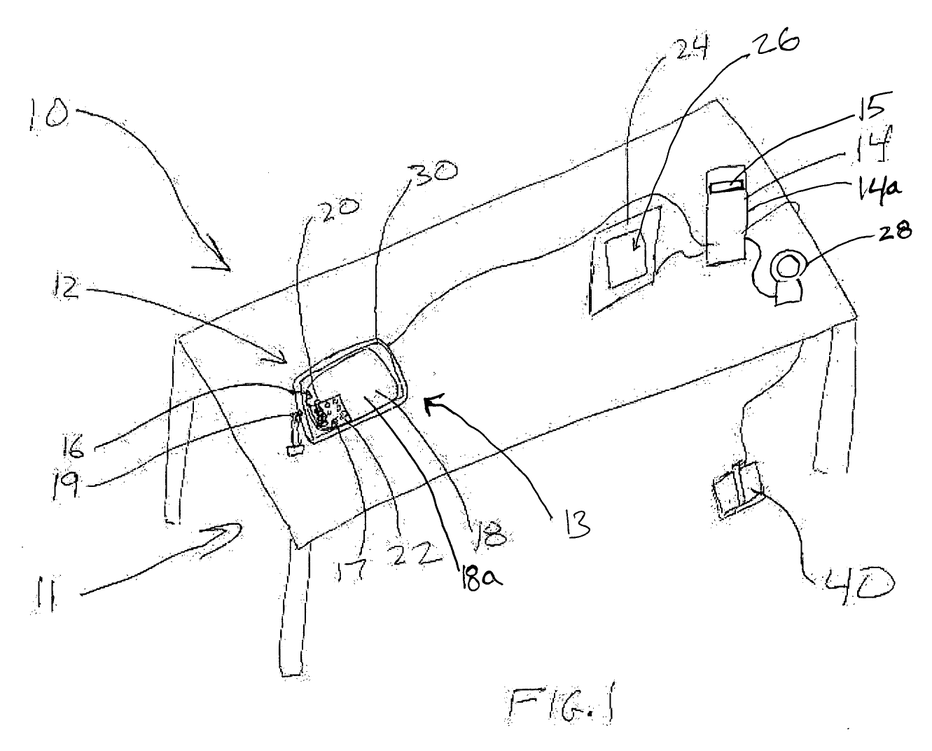

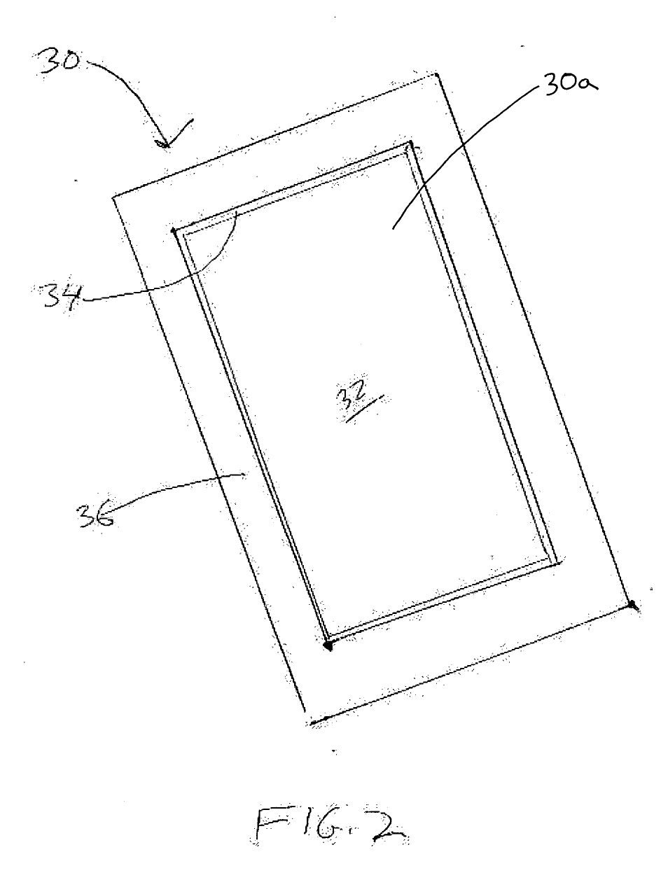

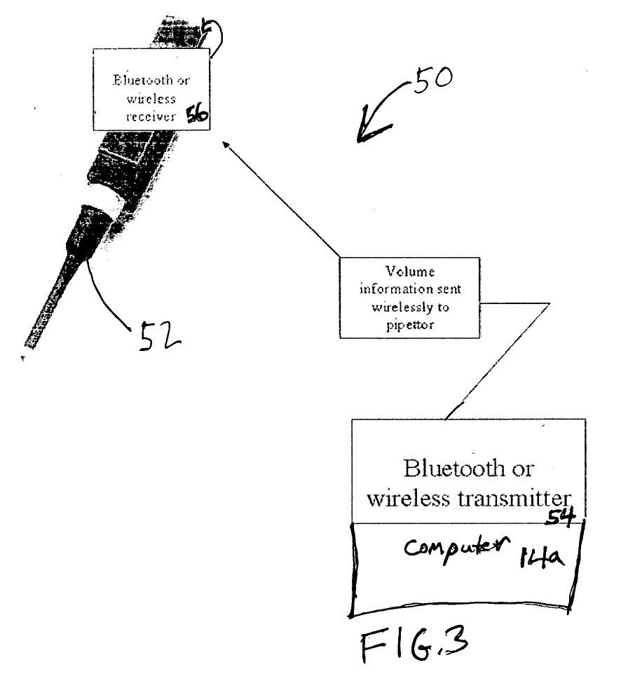

Referring to FIGS. 1-2, the semi-automated pipetting aid 10 generally is used at workstation 11 and includes a computer monitor 12, a screen protector 30 mounted on the computer monitor 12 and one or more screen displays 16 shown on the computer monitor 12. A user transfers vials 20 to the pipetting aid 10 by placing each of the vials 20 upon the computer monitor 12 (or in a well plate 22 placed upon the screen 18) as respectively indicated by a target location 17 shown on the screen display 16. The well plate 22 may, for example, be a twenty-four, forty-eight, ninety-six, or three hundred eighty-four transparent or semitransparent well plate.

The computer monitor 12 is preferably a flat panel computer monitor 13 in communication with a CPU 14 contained in computer 14a. The computer monitor 12 may be other than a flat panel computer monitor so long as it is functional for mounting well plates 22 over the outer surface 18a of screen 18. The outer surface 18a should lie in a horizontal plane or in a primarily horizontal plane so that the well plate(s) 22 and vials 20 will rest and stabilize over the screen 18 under the influence of gravity. Preferably the computer monitor 12 has swivel joints 19 such that the outer surface 18a of screen 18 can be rotated to the horizontal or to a plane slightly sloped from the horizontal as desired by the user. However those skilled in the art will realize that there are other ways to make the screen 18 horizontal or nearly horizontal, and that there are many types of swivel joints 19 which may be used in the overall design of the system. Also, if the screen 18 lies in a plane which is nearly horizontal such would mean that the slope of the screen 18 from the horizontal would be sufficient for the vials 20 to be stable on top of the screen 18.

The screen protector or cover 30 is preferably used in the system to protect the computer monitor 12 from chemicals and/or moisture. Hence, the screen protector 30 is preferably made of a chemically resistant, transparent material, e.g., polyethelene perephthalate (“PET”) a polyester material. The screen protector 30 may be a sheet or layer 30a mounted over outer surface 18a of screen 18 or it may be embedded in/with the surface 18a. In the preferred embodiment, the screen protector 30 is made to match the computer monitor 12 including the surface 18a of the screen 18. Such a screen protector 30 has a planar interior surface 32 with sidewalls 34 adjoining to a raised peripheral surface 36. In one example, the interior surface 32 is approximately eleven inches by 8.25 inches, the sidewalls 34 are about 5/16th of an inch high, and the peripheral surface 36 is about from one-half inch to one inch wide. The screen protector 30 could include a template indicating a location for the proper placement of a well plate 22. The screen protector 30 could be made in other manners such as, for example, a screen 18 with fluid tight joints.

The processing unit or CPU (central processing unit) 14 may be integral with or separate from the computer monitor 12. The CPU 14 will enable a computer program or software 15 to generate or create the screen display 16. In the current preferred embodiment MICROSOFT EXCEL software is the software 15 used to create the screen displays 16, including spreadsheets 16a, target locations 17, etc. One skilled in the art may implement other software 15.

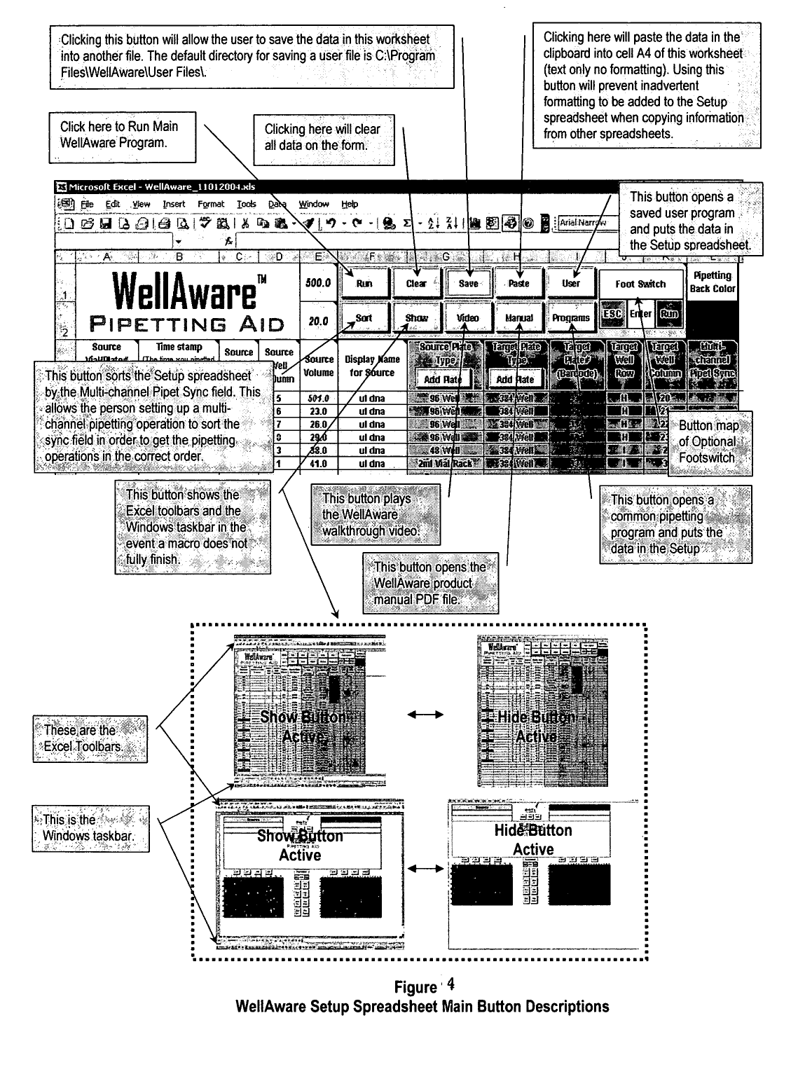

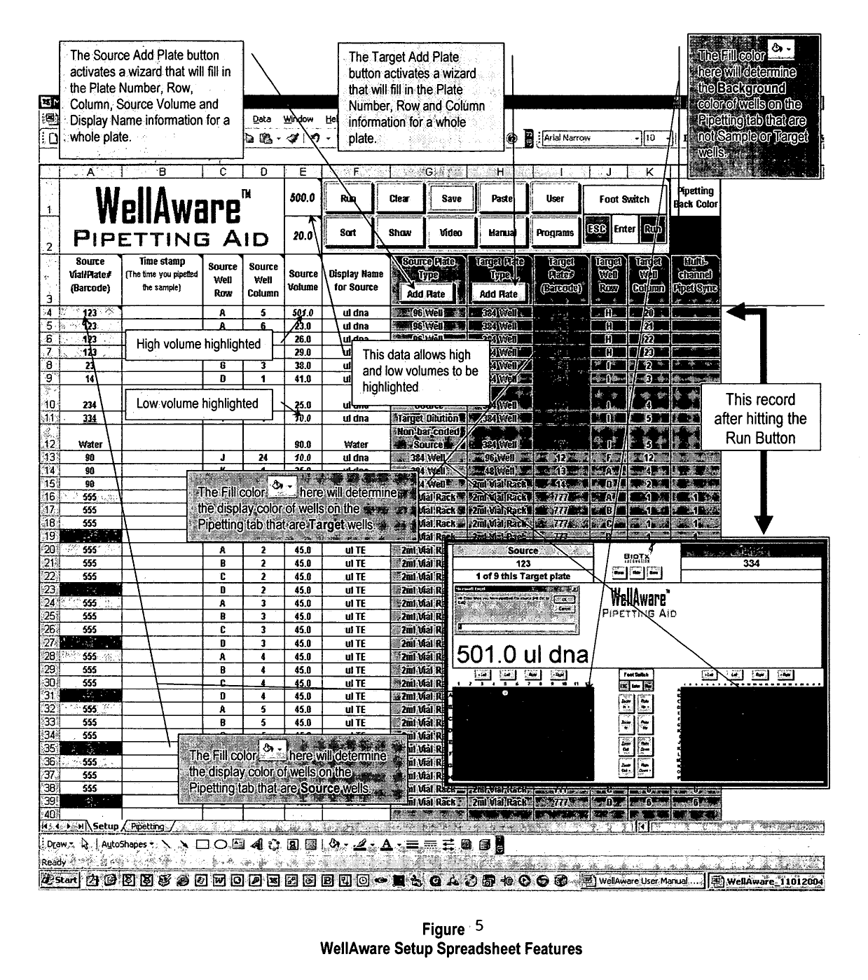

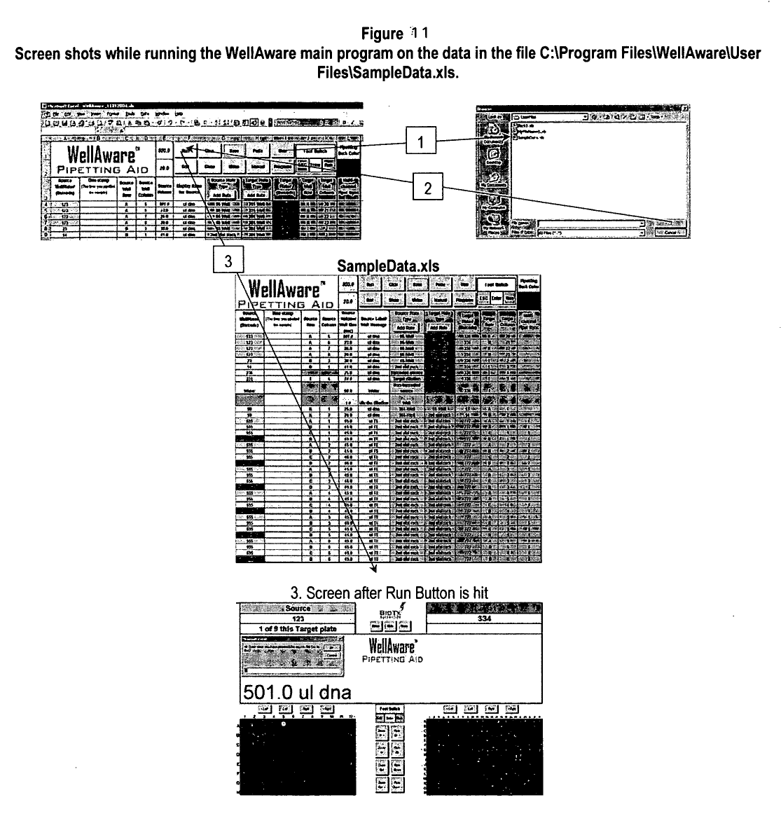

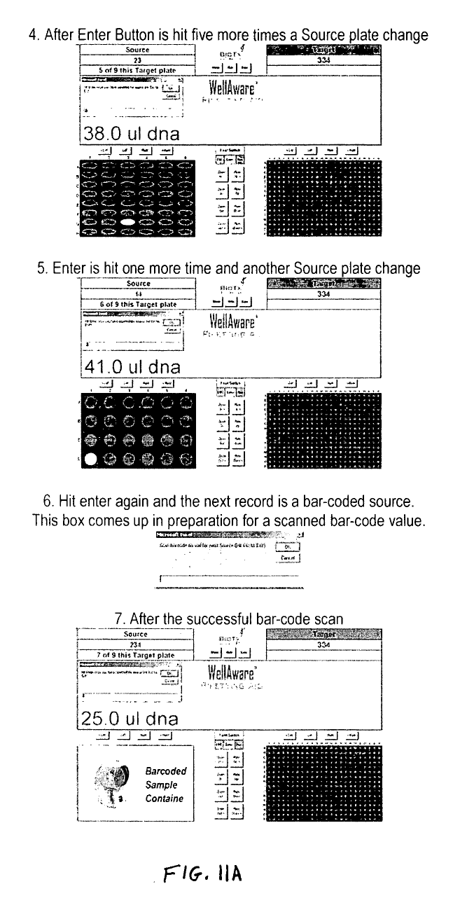

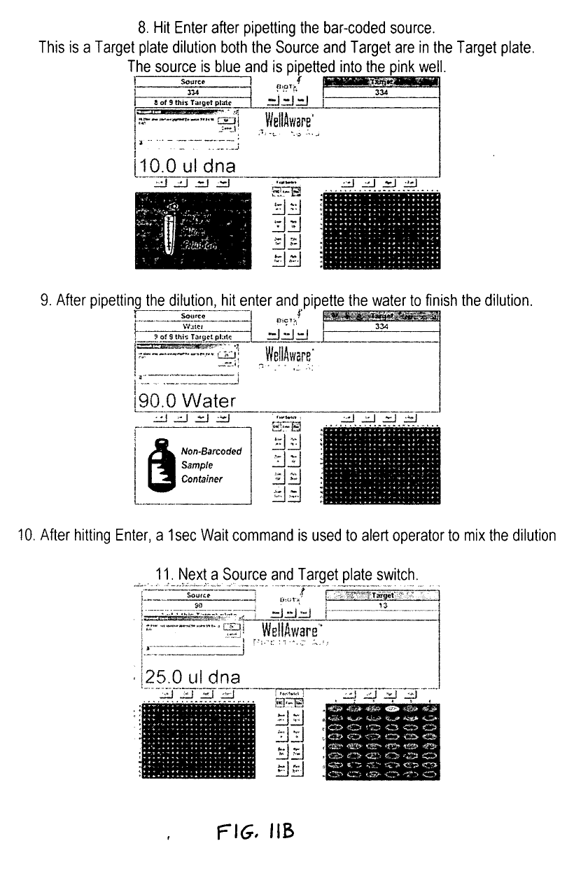

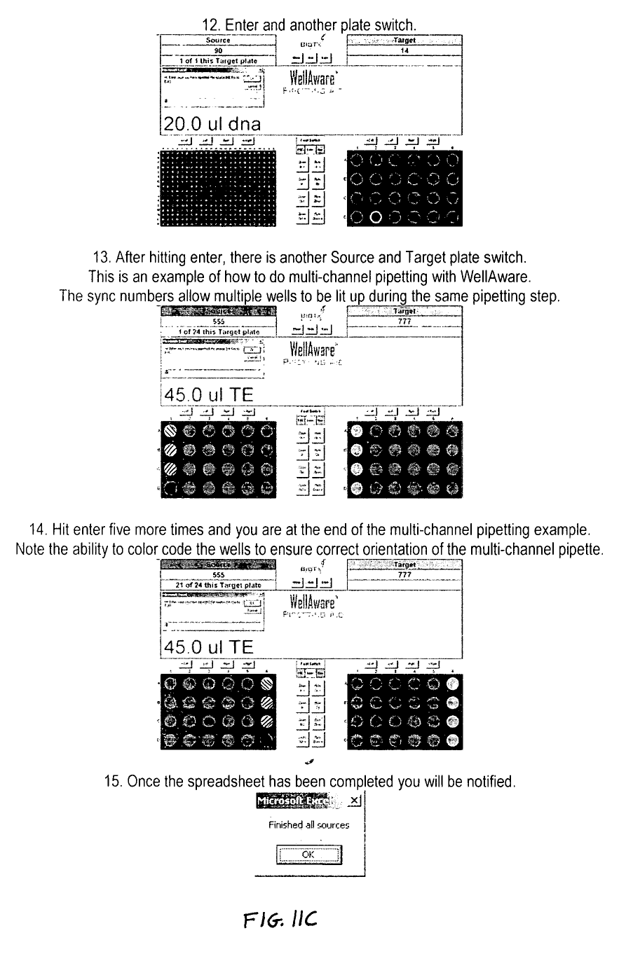

A sample User Manual excerpt for using the software 15 appears below and FIGS. 4-12 are working examples of screen displays 16 generated by the software 15 (including additional reference information to assist in describing the use and functionality of the software together in the semi-automated pipetting aid 10 system):
The WellAware software has two tabs Setup and Pipetting. The Setup tab contains a table of information that the user may modify to customize pipetting functions (see FIG. 5). The user fills in the table with the Source: name, number, volume, units & well location and the Target: number, well location, vial or plate types and (if multi-channel pipetting) a sync number. The table may be filled out manually or the Add Plate wizards may be used to speed up data entry. The (Fill Color) button in EXCEL is used to set the Sample, Target and Background colors in WellAware. Simply select the Source or Target Plate number that you want to set the color for, click on the Fill Color button, and select the color you want. When the program is run, the Source or Target well will be lit up with the selected color. To change the Background color click on cell L2 on the Setup tab and select the Fill color you want. Once the Setup spreadsheet is filled in, the operator hits the right key on the footswitch or clicks the Run button (see FIG. 4) on the Setup spreadsheet. The software will light up the appropriate wells for pipetting on the LCD screen (see FIG. 9). Once the operator has finished the pipetting of the first sample, they hit the middle footswitch button or the enter key. The program timestamps the pipetting action in the Setup spreadsheet and then will light up the next source to be pipetted. There is also a bar-code function described in detail in the Accessories section of this manual and FIG. 11. If you want to save your pipetting data for future reference, you may hit the Save button to save your data to a new spreadsheet. You should note that you can't save data in WellAware other than through the Save button. If you ever wish to redo a saved pipetting spreadsheet click the User button, select the file you want to redo and the program will put it in the Setup spreadsheet for you. Alternatively, the user can simply copy data from a saved worksheet (cells A4 to L#####) then switch over to the WellAware Setup tab and click the Paste button. Before hitting Paste, make sure the data is in the same order as the Setup spreadsheet or the program will not function properly. The Paste button will paste the data into cell A4 and preserve the formatting in the WellAware Setup tab (by performing a paste special text only). It may then be necessary to remove the old timestamp data and add user specified color formatting for the Background, Target and Source before hitting the Run button. To clear the data and formatting from the Setup spreadsheet, use the Clear button. The Manual button and Video buttons are conveniently located on the Setup tab and provide easy access to this manual and instructional video.
   Pipetting Options

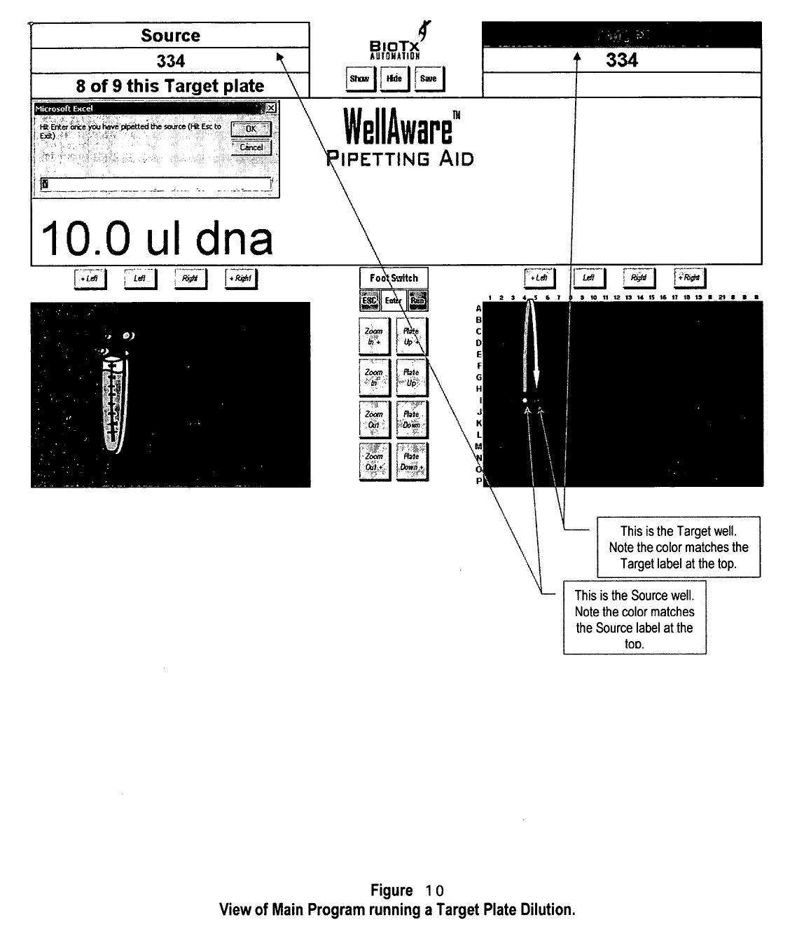

The pipetting options are available for selection under the Source Plate Type and Target Plate Type list boxes on the Setup tab of WellAware. Please not that not all pipetting options are available under the Pipetting From list box.
Wait: This command is used to time a step in your protocol and/or alert the operator to do something with a message box. If you put a time in the program will wait the specified number of seconds, say the text message and finally display the message text in a message box. This selection is only available on the Source plate type pull down list. (FIG. 11)
24-Well: The 4×6 grid pattern may be used for vials or a 24-well plate. This selection is available on the Source and Target plate type pull down list.
384-Well: The 384-well plate selection is available on the Source and Target plate type pull down list.
48-Well: The 48-well plate selection is available on the Source and Target plate type pull down list.
96-Well: The 96-well plate selection is available on the Source and Target plate type pull down list.
Barcoded Source: Used for bar-coded vials or containers. This option is ideal for making or filling holes in master plates. This selection is only available on the Source plate type pull down list. (FIGS. 8, 9, & 11)
Non-barcoded Source: This selection is used for bottles or reagent troughs (TE, water or a dilution solvent like DMSO). This selection is only available on the Source plate type pull down list. (FIGS. 8 & 11)
Target Dilution: This selection is used for doing serial or ratio dilutions in the Target plate. Both the Source and Target wells are illuminated on the same Target plate. This selection is only available on the Source plate type pull down list. (FIGS. 8, 10, & 11)
   Common Pipetting Programs

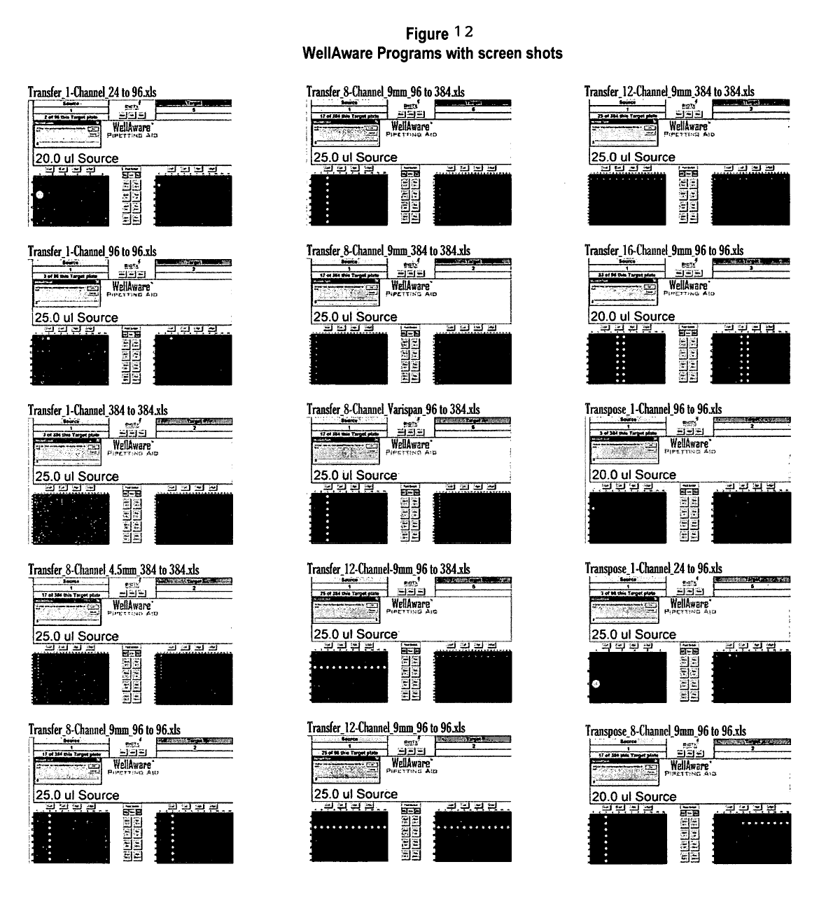

The Programs button on the WellAware Setup tab provides access to a number of common pipetting programs. Programs include transposing using single and 8-channel pipettors with various plate configurations. WellAware also includes programs for transfers using single, 8, 12 & 16-channel pipettors and 8-channel 9 mm to 4.5 mm variable span pipettors utilizing various plate configurations. FIG. 12 includes screenshots of the current list of common pipetting functions. Bio TX will make new pipetting programs available on it's website as they become available. To run these programs simply click the Programs button and select the program name that describes the activity you want to use and the data will be transferred to the Setup Tab for formatting and editing. Once the data is ready, hit the Run button to begin pipetting.

Customizable Screen

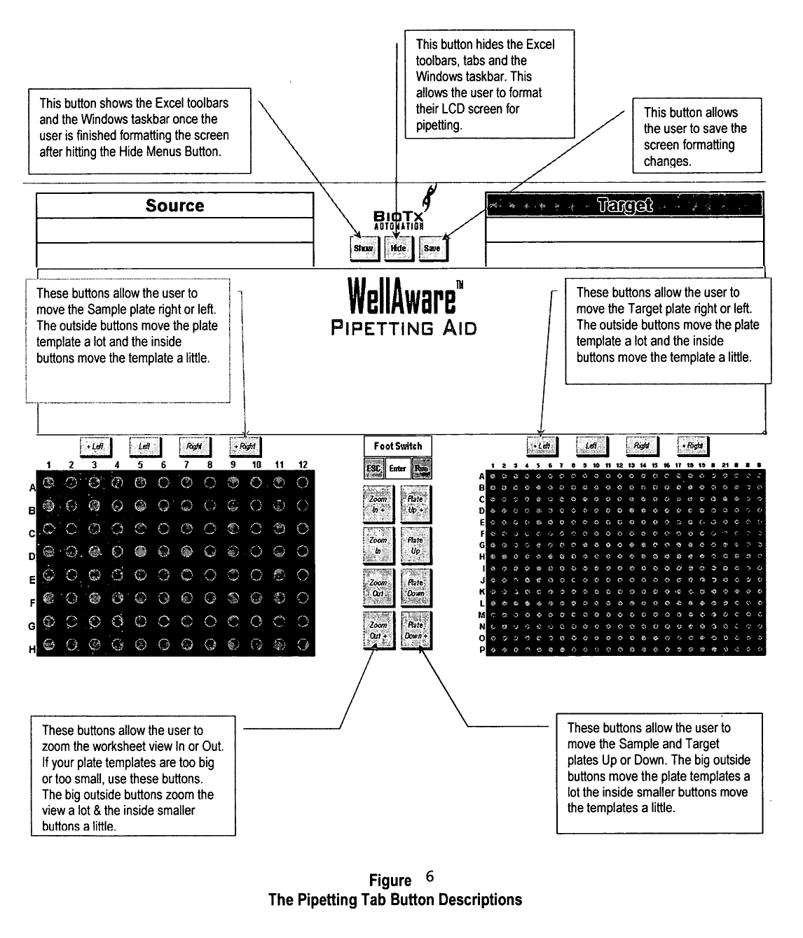

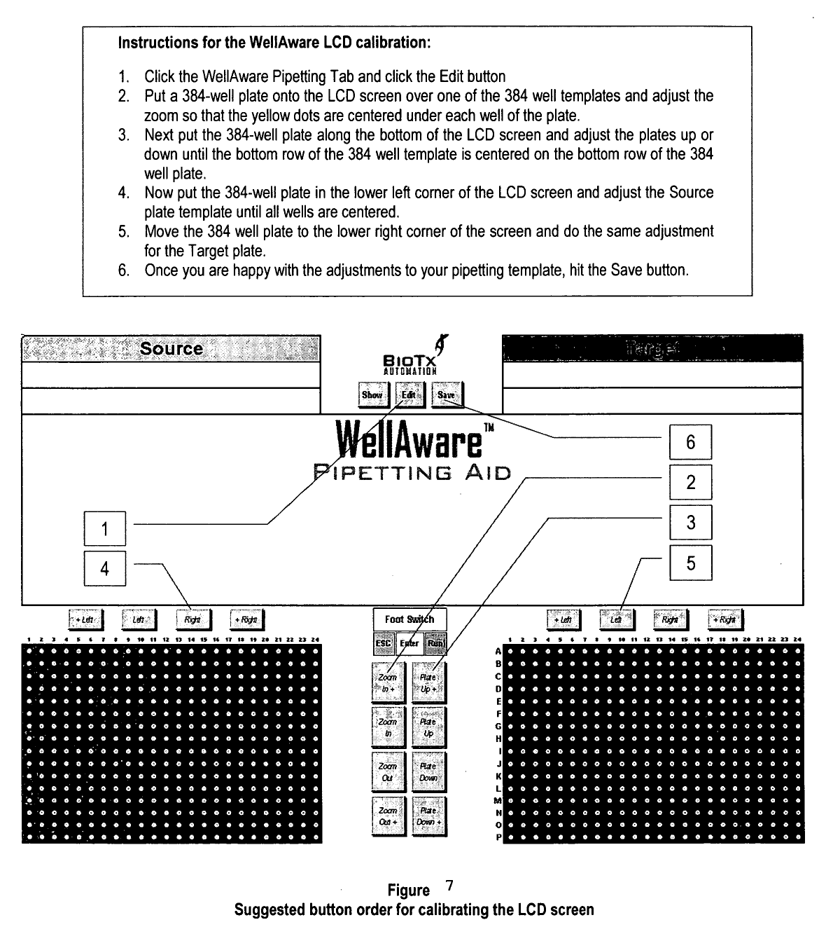

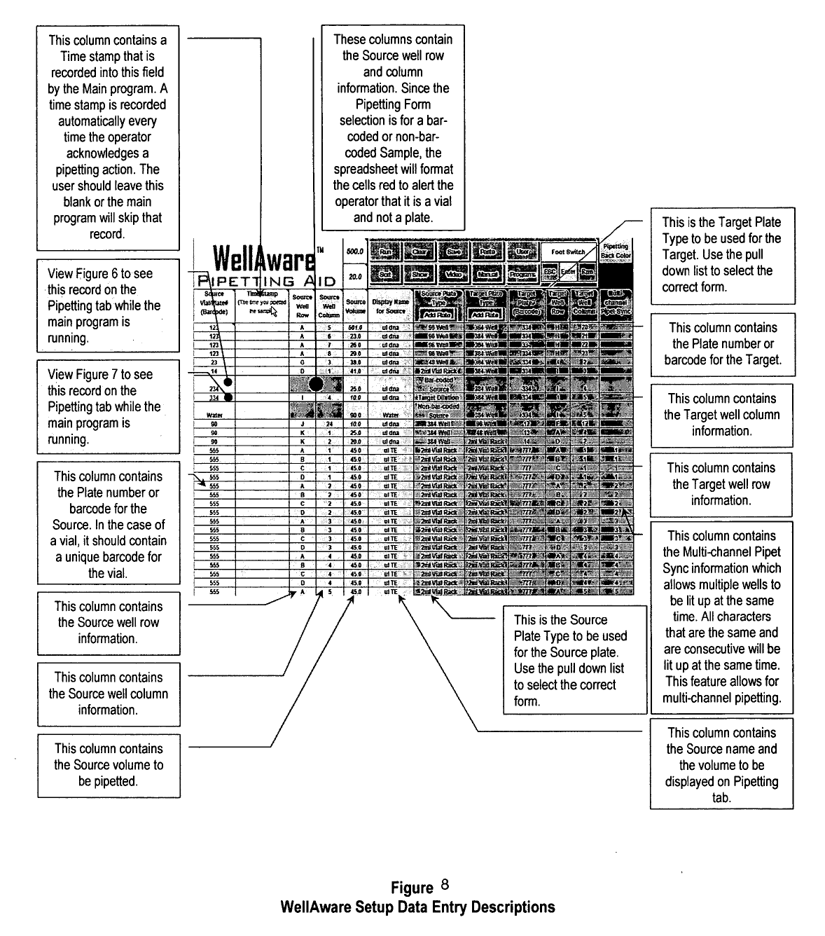

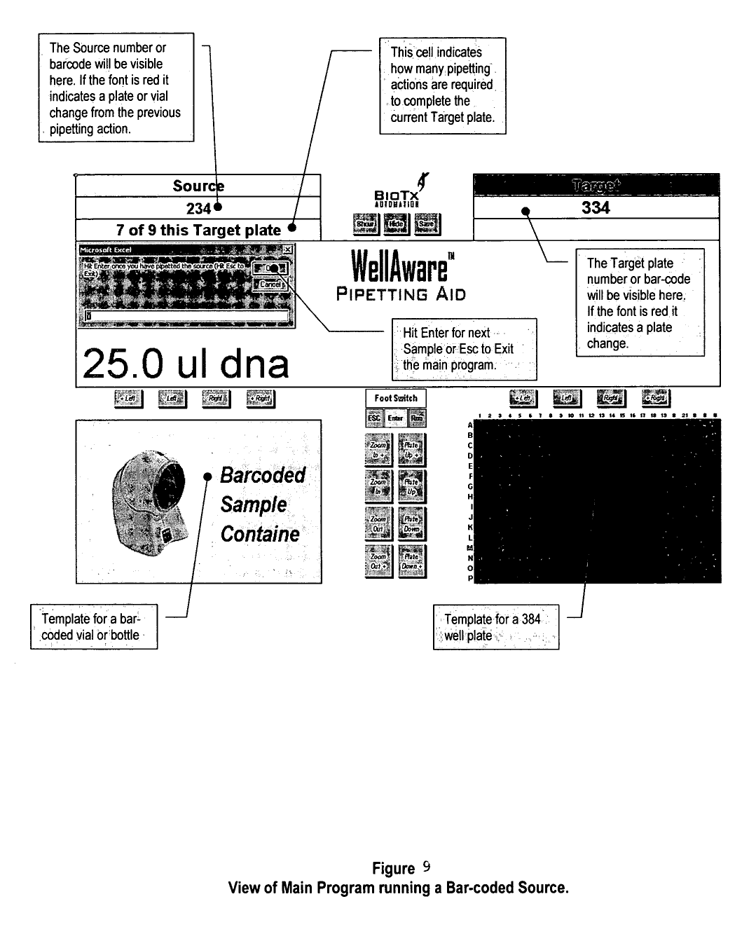

On the Pipetting Tab there is a series of buttons that will allow the user to custom configure the WellAware program to any computer screen (FIG. 6). If the screen is not properly formatted once you start one of the pipetting programs on the Programs tab of WellAware, simply hit the ESC to exit out of the program. Then hit the Hide button on the Pipetting Tab. Next, place your plates on the screen and use the Source and Target Left/Right buttons, the Plate Up/Down buttons and the Zoom In/Out buttons to configure the screen for your computer. Once the plate wells are aligned with the wells on the PC's screen, hit the Save button. Your settings are now saved and you can continue with your pipetting. The next time you open WellAware your changes will still be in effect. Detailed instructions for aligning the screen are provided in FIG. 7 of this manual.

Accessories

Monitor & Screen cover—Bio TX has a 180-degree tilt modified fourteen inch LCD screen, which comes with a disposable chemical resistant screen cover. The covers are made of PET plastic and are resistant to most solvents, acids and bases (plastic soft drink bottles are made out of PET). The screen and the covers are available for purchase with or without the WellAware software.

Foot switch—A three-button USB foot switch is available for the hands-free operation of the WellAware programs. The Left button is the ESC key, the middle button is the Enter key and the right button is the combination of the Ctrl+Shift+R the equivalent of hitting the Run button on the Setup tab of WellAware.

Barcode reader—The main WellAware program can be used with bar-coded vials or containers. It is recommended that all bar-coded vials be grouped together in the Setup spreadsheet before hitting the Run button and that all bar-coded vials be processed at the same time. When a bar-coded record is encountered by the software an input box, will pop-up and ask the operator to scan the barcode. When the barcode is scanned, the correct record is found in the Setup spreadsheet and the correct Target well is illuminated. This function is ideal for making master plates from vials, filling holes in master plates, cherry picking and combi-chem type applications.

The software 15 may be used in conjunction with a computer network and with more than one computer monitor. For example, a user may desire to make data entries while viewing a display 26 on a second computer monitor 24 whilst the computer monitor 12 is used for the organized placement and arrangement of vials 20.

The screen display 16 works in conjunction with (is generated by) the CPU 14 and software 15 to indicate a target location 17 for each vial 20 on the screen display 16. The target location 17 is principally represented by a visual cue, such as, by way of example, a red light appearing within what was previously a white circle appearing against a black background. Other cues such as an audible cue or text to speech (voice prompting) may be used as well. For example, an audible cue may be used to inform the operator that the screen display 16 is ready for placement of a vial 20 which was just bar code scanned by a linked scanner 28 into the system.

In another example, the screen protector 30 is mounted over outer surface 18a on the computer monitor 16. A semi-transparent well plate 22 is placed on the screen protector 30 in a location indicated by lights on the screen display 16. The screen display 16 then lights up a red light which can be seen through the semi-transparent well plate 22 to indicate to the operator where a vial 20 should be transferred and placed within the well plate 22. The CPU 14 will process data so that a record is kept of the placement location and contents of each individual vial 20.

A foot control 40 may be used with the semi-automated pipetting aid 10. The foot control 40 can be used by the operator to, for example, cue the system that the operator has completed a specific or specified task, to move on to the next transfer, etc. The foot control allows the operator's hands to be free to pipet liquids into vials 20 or plates 22, scan bar codes located on vials 20, apply bar code labels, etc.

A wired or wireless, or “bluetooth” system 50 can be added to the overall system. The wireless or “bluetooth” system 50 is used to automate volumetric dispensation from a stand-alone pipette header 52. In such a system 50, the computer sends volumetric dispensation data to the pipette header 52. This will automate the volume of a liquid dispensed into a pipette 20 (e.g. 9.5 milliliters) once the operator simply initiates the dispensation of the liquid into a vial 20. A “bluetooth” or wireless card 54 is mounted in the computer 14a, and a “bluetooth” or wireless port/receiver 56 is located in the pipette header 52. As known to one of ordinary skill in the art, the wireless port/receiver 56 can be used to implement control signals and functionality for the pipette header 52.

The software 15 generated spreadsheet 16a (FIGS. 4-12) may be used to program in all actions of a protocol including wait/pause and action steps. This allows any operator of the software 15 to repeat a protocol at a later time with increased reproducibility. In addition, very complex protocols may be attempted whereas previously such complex protocols would not normally be attempted due to the high probability of user error.

What is claimed is:

1. A semi-automated pipetting apparatus, comprising:
a computer monitor including a screen lying in at least a nearly horizontal plane;
a processing unit running a computer program in communication with said computer monitor;
a screen display generated by the processing unit and the computer program, and shown on a screen of said computer monitor; and
wherein the screen display indicates at least one target location for a vial.

2. The apparatus according to claim 1 further including a means for protecting said computer monitor located on the screen of said computer monitor.

3. The apparatus according to claim 2 wherein said means for protecting said computer monitor comprises a screen protector layer mounted on an outer surface of said computer monitor.

4. The apparatus according to claim 3 wherein said screen protector layer comprises a planar interior surface, an adjoining sidewall, and an adjoining raised peripheral surface.

5. The apparatus according to claim 3 wherein said screen protector layer is made of polyethelene perephthalate.

6. The apparatus according to claim 1 wherein said computer monitor is a flat panel computer monitor.

7. The apparatus according to claim 1 wherein said computer monitor includes a stand and a swivel joint joining said stand to the screen of said computer monitor.

8. The apparatus according to claim 1, further including a foot control in communication with the processing unit.

9. The apparatus according to claim 1, further including a second computer monitor in communication with the processing unit.

10. The apparatus according to claim 9, wherein the second computer monitor has a display which is different than that shown on the screen display.

11. The apparatus according to claim 1, further including:
a stand-alone pipette header including a receiver having a means for controlling said stand-alone pipette header; and
a transmitter mounted in a computer and in communication with the processing unit and with the receiver.

12. The apparatus according to claim 1, wherein the computer program is MICROSOFT EXCEL.

13. The apparatus according to claim 1, further including a scanner in communication with the processing unit and at least one bar code label applied to the vial.

14. A method for semi-automating the filling of vials in a laboratory, comprising the steps of:
placing a computer monitor such that a screen of the computer monitor lies in a nearly horizontal plane;
generating a screen display via a processing unit running a computer program in communication with the computer monitor;
indicating at least one target location for a vial on the screen display; and placing a vial on top of the screen and the target location.

15. The method according to claim 14 wherein said step of placing the computer monitor comprises adjusting an angle of the screen of the computer monitor.

16. The method according to claim 14 further comprising the step of controlling the screen display by motion of foot.

17. The method according to claim 14, further comprising the steps of:
sending signals from a computer to a stand-alone pipette header; and
controlling a volume of liquid to be dispensed from the stand-alone pipette header by means of said prior step.

18. The method according to claim 14, further comprising the step of programming actions of a protocol for the filling of vials via the computer program.

19. The method according to claim 18, wherein said step of programming actions of the protocol includes steps of pausing for the filling of vials and subsequently acting to fill at least one vial.

20. The method according to claim 18, further including the step of repeating the protocol at a later time.

21. The method according to claim 14, further comprising the step of providing an audible cue for prompting an operator-initiated response.

22. The method according to claim 14, further comprising the step of placing a screen protector on top of the screen.

23. The method according to claim 14 wherein the step of indicating the target location for the vial on the screen display includes scanning a bar code label.

24. The method according to claim 17, wherein said step of sending signals from the computer to the stand-alone pipette header comprises sending a wireless signal.

25. The method according to claim 17, wherein said step of sending signals from the computer to the stand-alone pipette header comprises sending signals on a hard-wired line.
